(19) United States
(12) Patent Application Publication
(10) Pub. No.: US 2026/0178214 A1
(43) Pub. Date: Jun. 25, 2026

(54) PARAMETER ENHANCED SEQUENTIAL PROGRAMMING METHOD

(71) Applicant: Silicon Storage Technology, Inc., San Jose, CA (US)

(72) Inventors: Viet Nguyen, Ho Chi Minh (VN); Thoan Nguyen, Dong Nai (VN); Nghia Nguyen, Ho Chi Minh (VN); Jong-Won Yoo, Morgan Hill, CA (US); Yen Jung Shen, Tainan (TW); Man-Tang Wu, Hsinchu (TW); Jeng-Wei Yang, Hsinchu (TW)

(21) Appl. No.: 19/181,816

(22) Filed: Apr. 17, 2025

Related U.S. Application Data
(60) Provisional application No. 63/737,605, filed on Dec. 20, 2024.

(51) Int. Cl. G06F 3/06

(52) U.S. Cl. CPC G06F 3/0655; G06F 3/0604; G06F 3/0679

(57) ABSTRACT

A method of programming a memory cell having a floating gate by applying a first program pulse to the memory cell to place electrons on the floating gate, wherein the first program pulse comprises a program voltage that includes a preliminary voltage level in a first portion of the first program pulse and a first voltage level in a second portion of the first program pulse, wherein the first voltage level is greater than the preliminary voltage level. The first voltage level is applied immediately successive to the preliminary voltage level. Then, applying successive program pulses to the memory cell to place additional electrons on the floating gate, wherein the successive program pulses include the program voltage, and wherein the program voltage increases in voltage level for each one of the successive program pulses relative to a previous one of the successive program pulses or the first program pulse.

### RELATED APPLICATIONS

This application claims the benefit of U.S. Provisional Application No. 63/737,605, filed Dec. 20, 2024, and which is incorporated herein by reference.

### FIELD OF THE INVENTION

The present invention relates to non-volatile memory cells of semiconductor devices, and more particularly to a technique of programming memory cells.

### BACKGROUND OF THE INVENTION

Split-gate non-volatile memory semiconductor devices are well known in the art. See for example U.S. Pat. No. 7,868,375, which discloses a four-gate memory cell configuration, and which is incorporated herein by reference for all purposes. Specifically, FIG. 1 of the present disclosure illustrates a pair of split gate non-volatile memory cells 10 each with spaced apart source and drain regions 14/16 formed in a silicon semiconductor substrate 12. The source region 14 can be referred to as a source line SL (because it commonly is connected to other source regions for other non-volatile memory cells 10 in the same row or column), and the drain region 16 is commonly connected to a bit line. A channel region 18 of the semiconductor substrate 12 extends between the source/drain regions 14/16. A floating gate 20 is disposed over (i.e., vertically over and laterally overlapping) and insulated from (and directly controls the conductivity of) a first portion of the channel region 18 (and partially over, and insulated from, the source region 14). A control gate 22 is disposed over, and insulated from, the floating gate 20. A select gate 24 (also referred to as a word line gate) is disposed over, and insulated from, and directly controls the conductivity of, a second portion of the channel region 18. An erase gate 26 is disposed over and insulated from the source region 14 and is laterally adjacent to the floating gate 20. The erase gate 26 can include a notch that faces an edge of the floating gate 20.

A plurality of such memory cells 10 can be arranged in rows and columns to form a memory cell array, as illustrated in FIG. 2. While FIG. 1 only shows a pair of memory cells 10 (sharing a common source region 14 and erase gate 26), the memory cell pairs can be placed end to end to form a column of memory cells 10 (where the memory cell pairs can share a common drain region 16). While only two such columns are shown in FIG. 2, there can be many such columns. Each column can include a bit line 16a electrically connecting together all the drain regions 16 in the column. Each row of memory cells 10 can include a control gate line 22a electrically connecting together all the control gates 22 in the row of memory cells 10. For example, all the control gates 22 in each row of memory cells 10 can be formed as a continuous line of conductive material, where a portion of the continuous line passing through any given memory cell 10 serves as its control gate 22. Each row of memory cells 10 can include a select gate line 24a electrically connecting together all the select gates 24 in the row of memory cells 10. For example, all the select gates 24 in each row of memory cells 10 can be formed as a continuous line of conductive material, where a portion of the continuous line passing through any given memory cell 10 serves as its select gate 24. Each row of memory cell pairs can include an erase gate line 26a electrically connecting together all the erase gates 26 in the row of memory cell pairs. For example, all the erase gates 26 in each row of memory cell pairs can be formed as a continuous line of conductive material, where a portion of the continuous line passing through any given memory cell pair serves as its erase gate 26. Finally, each row of memory cell pairs can include a source line 14a electrically connecting together all the source regions 14 in the row of memory cell pairs. For example, all the source regions 14 in each row of memory cell pairs can be formed as a continuous line of conductive diffusion in the semiconductor substrate 12, where a portion of the continuous line passing through any given memory cell pair serves as its source region 14.

Various combinations of voltages are applied to the control gate 22, select gate 24, erase gate 26 and source and drain regions 14/16, to program the split gate non-volatile memory cell 10 (i.e., place electrons onto the floating gate 20 by injection), to erase the split gate non-volatile memory cell 10 (i.e., remove electrons from the floating gate 20), and to read the split gate non-volatile memory cell 10 (i.e., measure or detect the conductivity of the channel region 18, by for example measuring or detecting a read current through the channel region 18, to determine the program state of the floating gate 20).

Split gate non-volatile memory cell 10 can be operated in a digital manner, where the split gate non-volatile memory cell 10 is set to one of only two possible states: a programmed state and an erased state. The split gate non-volatile memory cell 10 is erased by placing a high positive voltage on the erase gate 26, and optionally a negative voltage on the control gate 22, to induce tunneling of electrons from the floating gate 20 to the erase gate 26 (leaving the floating gate 20 in a more positively charged state—the erased state). Split gate non-volatile memory cell 10 can be programmed by placing positive voltages on the control gate 22, erase gate 26, select gate 24 and source region 14, and a current on drain region 16. Electrons will then flow along the channel region 18 from the drain region 16 toward the source region 14, with electrons becoming accelerated and heated whereby some of them are injected onto the floating gate 20 by hot-electron injection (leaving the floating gate 20 in a more negatively charged state—the programmed state).

Split gate non-volatile memory cell 10 can be read by placing positive voltages on the select gate 24 (turning on the portion of channel region 18 under the select gate 24 by making it conductive) and drain region 16 (and optionally on the erase gate 26 and the control gate 22), and sensing current flow through the channel region 18. If the floating gate 20 is positively charged (i.e. split gate non-volatile memory cell 10 is erased), the split gate non-volatile memory cell 10 will turn on because the both portions of the channel region 18 are conductive due to the lack of electrons on the floating gate 20, and electrical current will flow from drain region 16 to source region 14 (i.e. the split gate non-volatile memory cell 10 is sensed to be in its erased “1” state based on sensed current flow). If the floating gate 20 is negatively charged (i.e. split gate non-volatile memory cell 10 is programmed), the portion of channel region 18 under the floating gate is turned off (low conductivity), thereby preventing appreciable current flow (i.e., the split gate non-volatile memory cell 10 is sensed to be in its programmed “0” state based on no, or minimal, current flow). Memory cells 10 are considered non-volatile because they maintain their program state even when power is not applied to the semiconductor device. Memory cells 10 can be referred to as split gate non-volatile memory cells because two different gates (floating gate 20 and select gate 24), respectively, directly control the conductivity of two different portions of the channel region 18.

Table 1 below provides non-limiting examples of the voltages that can be used to perform the read, erase and program operations on the memory cell 10 of FIG. 1.

TABLE 1

| Operation | SG 24 | | Drain 16 | | CG 22 | | EG 26 | | Source 14 | |
|---|---|---|---|---|---|---|---|---|---|---|
| Read | 1.0-2 | V | 0.6-2 | V | 0-2.6 | V | 0-2.6 | V | 0 | V |

| | | | | | | | | |
|---|---|---|---|---|---|---|---|---|
| Erase | −0.5 V or 0 V | 0 | V | 0 V or −8 V | 8-12 | V | 0 | V |

| | | | | | | | | | |
|---|---|---|---|---|---|---|---|---|---|
| Program | 1 | V | ~0.3 V (1 uA) | 8-11 | V | 4.5-9 | V | 4.5-5 | V |

One technique to program the memory cells 10 is sequential programming, which involves applying the programming voltages as a series of pulses, with each pulse of programming voltages injecting additional electrons onto the floating gate thus increasing the program state of the memory cell 10 with each pulse, until the desired program state (also referred to as the target program state) is achieved (i.e., until the target read current for the target program state is achieved). With sequential programming, there can be intervening read operations between the programming pulses to determine if the target program state has been achieved by the last applied programming pulse (in which case programming ceases) or has not been achieved (in which case programming continues with one or more programming pulses). For example, each target program state can be associated with a target read current Irtarget (i.e., the desired and therefore target current through the channel region 18 during a read operation that is associated with the target program state). The higher the program state (i.e., the more electrons on the floating gate), the lower the read current Ir. Therefore, read current Ir will drop after each programming pulse. Once a target read current Irtarget is reached (reflecting the desired or target program state), programming for that memory cell 10 ceases.

If the same set of program voltages are applied during each pulse in sequential programming, the programming amount drops pulse to pulse, because as the floating gate becomes more negatively charged with each pulse, fewer electrons are injected onto the floating gate if the parameters of the programming pulses (applied voltages, supplied current, duration) remain constant. Therefore, when a memory cell 10 is determined to have not reached its target program state after any given pulse, one or more of the programming parameters can be stepped up to a higher value in the next pulse, to compensate for the dropping pulse-to-pulse programming amount that would otherwise occur. For example, for the memory cell 10 of FIG. 1, programming parameters that can be stepped up from one programming pulse to the next programming pulse can include increases in one or more of the following: voltage applied to the control gate, voltage applied to the erase gate, voltage applied to the source region, current supplied to the drain region, and duration of the programming pulse.

Split gate non-volatile memory cell 10 can alternately be operated in an analog manner where the program state (i.e. the amount of charge, such as the number of electrons, on the floating gate 20) of the split gate-non-volatile memory cell 10 can be incrementally changed anywhere from a fully erased state (minimum number of electrons on the floating gate 20) to a fully programmed state (maximum number of electrons on the floating gate 20), or just a portion of this range. This means the split gate non-volatile memory cell 10 storage is analog, which allows for very precise and individual tuning of each split gate non-volatile memory cell 10 in an array of split gate non-volatile memory cells 10. Alternatively, the split gate non-volatile memory cell 10 could be operated as an MLC (multilevel cell) where it is configured to be programmed to one of many discrete values (such as 16 or 64 different values).

Split gate non-volatile memory cells with fewer gates are also known. For example, FIG. 3 illustrates known split gate non-volatile memory cells 10 that are the same as that of FIG. 1, except the control gates 22 are omitted. See for example U.S. Pat. No. 7,315,056, which is incorporated herein by reference for all purposes. Voltage coupling to the floating gate 20 provided by the control gate 22 of the split gate non-volatile memory cell 10 of FIG. 1 is provided instead by the erase gate 26 and source region 14 of the split gate non-volatile memory cell 10 in FIG. 3. FIG. 4 illustrates an example layout of an array of the split gate non-volatile memory cells 10 of FIG. 3. Table 2 below provides non-limiting examples of the voltages that can be used to perform the read, erase and program operations on the memory cell 10 of FIG. 3.

TABLE 2

| Operation | SG 24 | | Drain 16 | | EG 26 | | Source 14 | |
|---|---|---|---|---|---|---|---|---|
| Read | 0.7-2.2 | V | 0.6-2 | V | 0-2.6 | V | 0 | V |

| | | | | | | | |
|---|---|---|---|---|---|---|---|
| Erase | −0.5 v or 0 V | 0 | V | 11.5 | V | 0 | V |

| | | | | | | | |
|---|---|---|---|---|---|---|---|
| Program | 1 | V | ~0.3 V (2-3 uA) | 4.5-9 | V | 7-9 | V |

There is a need to program memory cells as quickly, efficiently and reliably as possible without inducing undue stress or damage to the memory cell.

### BRIEF SUMMARY OF THE INVENTION

The aforementioned problems and needs are addressed by a method of programming a memory cell having a floating gate, the method comprising applying a first program pulse to the memory cell to place electrons on the floating gate, wherein the first program pulse comprises a program voltage that includes a preliminary voltage level in a first portion of the first program pulse and a first voltage level in a second portion of the first program pulse, wherein the first voltage level is greater than the preliminary voltage level, and wherein the first voltage level is applied immediately successive to the preliminary voltage level; and after applying the first program pulse, applying successive program pulses to the memory cell to place additional electrons on the floating gate, wherein the successive program pulses include the program voltage, and wherein the program voltage increases in voltage level for each one of the successive program pulses relative to a previous one of the successive program pulses or the first program pulse.

A semiconductor device, comprises a memory cell formed on a semiconductor substrate and having a floating gate; and control circuitry to apply a first program pulse to the memory cell to place electrons on the floating gate, wherein the first program pulse comprises a program voltage that includes a preliminary voltage level in a first portion of the first program pulse and a first voltage level in a second portion of the first program pulse, wherein the first voltage level is greater than the preliminary voltage level, and wherein the first voltage level is applied immediately successive to the preliminary voltage level; and after the first program pulse, apply successive program pulses to the memory cell to place additional electrons on the floating gate, wherein the successive program pulses include the program voltage, and wherein the program voltage increases in voltage level for each one of the successive program pulses relative to a previous one of the successive program pulses or the first program pulse.

Other objects and features of the present disclosure will become apparent by a review of the specification, claims and appended figures.

### BRIEF DESCRIPTION OF THE DRAWINGS

FIG. 1 is a cross sectional view of a conventional pair of memory cells.

FIG. 2 is a schematic and layout diagram of a conventional memory cell array of the memory cells of FIG. 1.

FIG. 3 is a side cross sectional view of a conventional pair of memory cells.

FIG. 4 is a schematic and layout diagram of a conventional memory cell array of the memory cells of FIG. 3.

FIG. 5 is a diagram illustrating components of a semiconductor device.

FIG. 6 is a graph diagram illustrating an example of a sequential program operation.

FIG. 7 is a flow diagram illustrating an example of a sequential program operation.

FIG. 8 is a graph diagram illustrating another example of a sequential program operation.

FIG. 9 is a graph diagram illustrating another example of a sequential program operation.

FIG. 10 is a graph diagram illustrating another example of a sequential program operation.

### DETAILED DESCRIPTION OF THE INVENTION

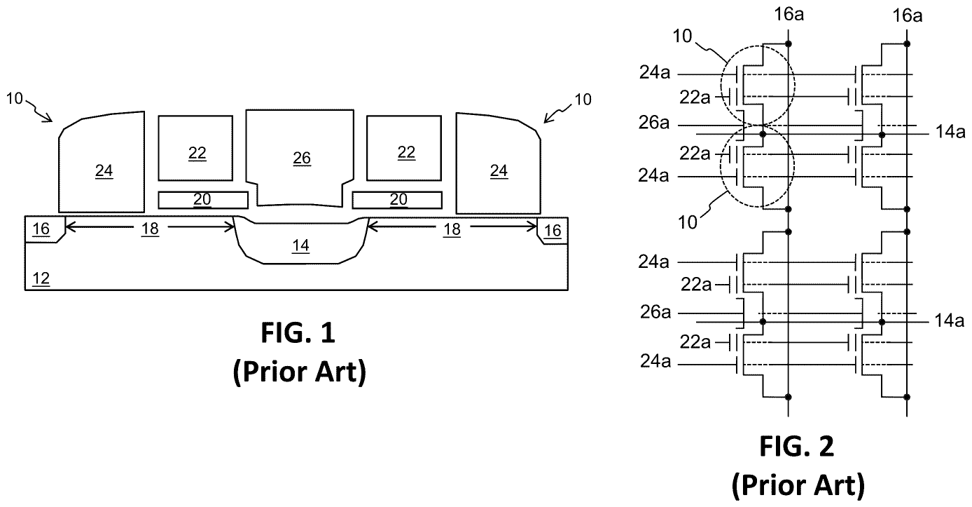

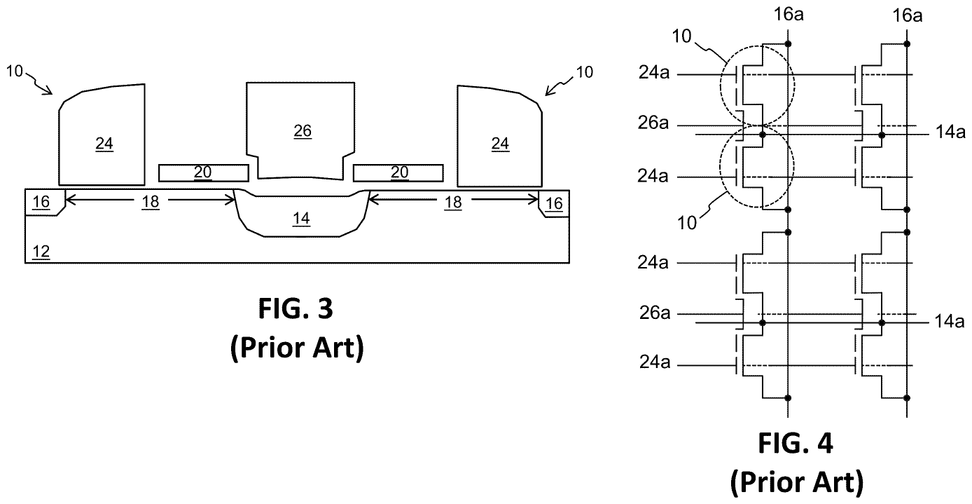

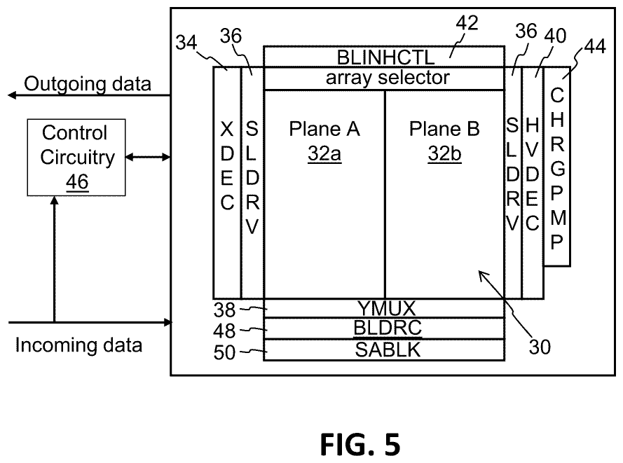

The present example illustrates a memory cell programing method that can be implemented as part of control circuitry 46, which controls the various device elements for a memory array, which can be better understood from the architecture of an example semiconductor device as illustrated in FIG. 5. The semiconductor device includes an array 30 of the split gate memory cells 10, which can be segregated into two separate planes (Plane A 32a and Plane B 32b). The split gate memory cells 10 can be of the type shown in FIG. 1 or 3, arranged in a plurality of rows and columns in the semiconductor substrate 12 as illustrated in FIG. 2 or 4, and thus formed on a single chip. Adjacent to the array 30 of split gate memory cells 10 are an address decoder 34 (e.g., XDEC), source line drivers 36 (e.g., SLDRV), a column decoder 38 (e.g., YMUX), a high voltage row decoder 40 (e.g., HVDEC), a bit line controller 42 (e.g., BLINHCTL), a bit line voltage/current source 48 (e.g., BLDRC), and a charge pump 44 (e.g., CHRGPMP), which are used to decode addresses and supply the various voltages to the various gates and regions of the split gate memory cells 10 during read, program, and erase operations for selected split gate memory cells 10 of the array 30, under the control of the control circuitry 46. Sense amplifier blocks 50 (e.g., SABLK) contain circuitry for measuring the currents on the bit lines during a read operation and supplying current during a program operation. Control circuitry 46 controls the various device elements to implement each operation (program, erase, read) on selected split gate memory cells 10 of the array 30 as described herein. Control circuitry 46 operates the semiconductor device to program, erase and read the selected split gate memory cells 10 of the array 30. As part of these operations, the control circuitry 46 can be provided with access to incoming data which is user data to be programmed to the selected split gate memory cells 10 of the array 30, along with program, erase and read commands provided on the same or different lines. Data read from the array 30 (i.e., from selected split gate memory cells 10 of the array 30) is provided as outgoing data.

The programming method involves the control circuitry 46 implementing memory cell programming. Thus, control circuitry 46 may be loaded with software, i.e. non-transitory electronically readable instructions, or firmware, or can consist of respective circuits, or any combination thereof, to perform the methods described herein. Control circuitry 46 may be implemented by a microcontroller, dedicated circuitry, a processor, a general purpose processor running firmware or software, or a combination thereof.

In operation, programming can be performed by applying the programming voltages in discrete pulses, with intervening read operations to verify the program state between programming pulses (i.e., sequential programming). Specifically, after each program pulse, a program verify read operation may be performed to determine if the selected cells have reached their respective target program state (i.e., reached their target read current Irtarget associated with the target program state). If the determination is yes for any given memory cell, then a program inhibit voltage can be applied for that given memory cell so that subsequent program pulses for the other cells do not further program the given memory cell. For example, once a memory cell in a particular row is determined to have achieved its target program state, a program inhibit voltage can be applied to the corresponding bit line to prevent further programming of that memory cell. Memory cells determined to have not reached their target program states are programmed with additional program pulses (also referred to as a program retry pulse train), often with a step-up in program parameter(s). The program retry pulse train continues until all the memory cells in the row to be programmed have reached their target program states.

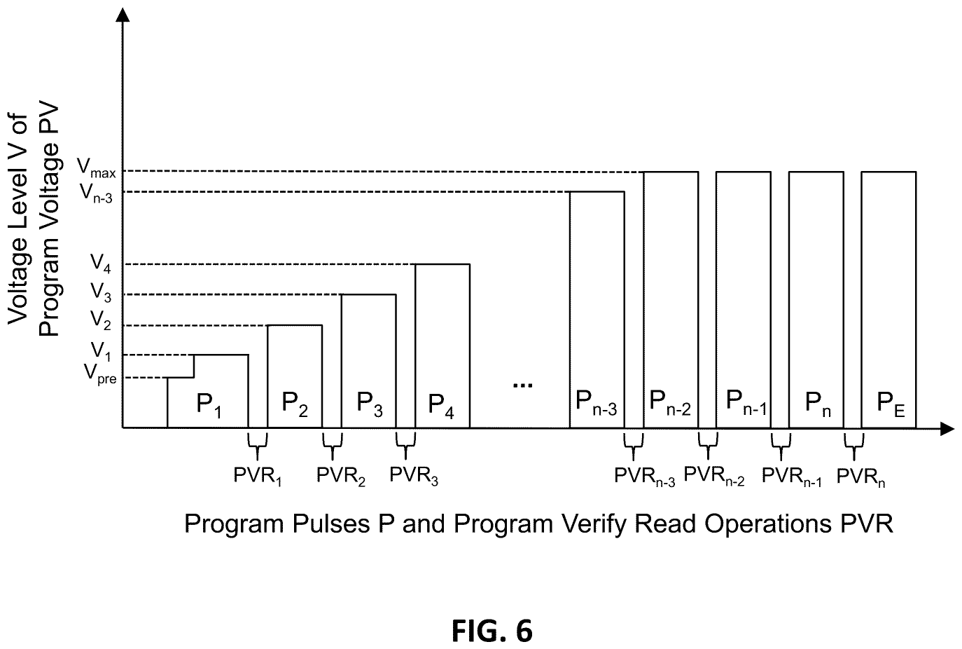

One issue with sequential programming is endurance (i.e., how many times the memory cell can be programmed over its lifetime before the memory cell becomes unreliable or defective). One failure mode can be stress and degradation of the insulation around the floating gate 20, and in particular the insulation between the floating gate 20 and the semiconductor substrate 12 (through which the electrons pass by hot-electron injection during the program operation). It has been determined that endurance can be improved by enhancing certain parameters of the program operation. FIG. 6 illustrates an example of a sequential program method and operation with endurance-improving parameter enhancements. The program voltage PV is one of the program voltages applied to the memory cell during the sequential program operation described above. For example, for the memory cell of FIG. 1, program voltage PV can be applied to the control gate 22, erase gate 26 or source region 14 (along with other voltage(s) applied to the memory cell for the hot-electron injection described above). For the memory cell of FIG. 3, the program voltage PV can be applied to the erase gate 26 or source region 14 (along with other voltage(s) applied to the memory cell for the hot-electron injection described above). The program voltage PV is applied (together with other voltages) to the memory cell in a series of program pulses P₁ to Pₙ₊₁, with a program verify read operation PVR between program pulses. As a non-limiting example, for the memory cell of FIG. 1, each program pulse P can include the program voltage PV applied to the control gate 22, along with other positive voltages applied to the erase gate 26, the select gate 24 and the source region 14, and along with current on drain region 16, where hot-electron injection occurs during each program pulse P. The program voltage PV of program pulses P₁ to Pₙ₊₁ have a voltage level V that can vary from pulse to pulse. As described above, if a program verify read operation PVR determines that the memory cell has achieved its desired program state, programming ends.

The first program parameter enhancement relates to the first program pulse P₁. Unlike the other pulses, the first program pulse P₁ includes successively applied first and second portions in which a program voltage PV applied to one of the elements of the memory cell (e.g., the control gate 22) has a preliminary voltage level Vₚᵣₑ in the first portion of the first program pulse P₁ and a first voltage level V₁ in the second portion of the first program pulse P₁. The first voltage level V₁ is greater than the preliminary voltage level Vₚᵣₑ. The preliminary voltage level Vₚᵣₑ is low enough that the first portion of the first program pulse (given its duration) is insufficient to program the memory cell to its lowest possible target program state. However, both the first and second portions of the first program pulse P₁ may be sufficient to program the memory cell to a target program state. Dividing the first program pulse P₁ into two portions, with the second portion applied immediately successive to the first portion (i.e., the two portions form a single program pulse with no intervening gap that would otherwise render the two portions to be two different program pulses, such that the first voltage level V₁ (of higher value) is applied immediately successive to the preliminary voltage level Vₚᵣₑ (of lower value)), has been found to reduce stress on the insulation layer between the floating gate 20 and the semiconductor substrate 12 that can result during an initial program pulse. Conventional sequential programming may include a first program pulse only having a program voltage PV with the first voltage level V₁. Applying a relatively high voltage V₁ to an erased memory cell (i.e., one with few electrons on the floating gate 20) can result in excessive hot-electron injection at the beginning of the first program pulse causing undesirable memory cell stress. However, merely lowering V₁ to a level that avoids excessive hot-electron injection is undesirable because it reduces the program effectiveness and efficiency of the first program pulse, thereby requiring one or more additional program pulses to achieve the desired target program state, thus making the program operation longer which is undesirable. Voltage level Vₚᵣₑ pre-programs the memory cell to a point that voltage level V₁ can be safely applied (i.e. avoiding excessive hot-electron injection that can damage the insulation layer between the floating gate 20 and the semiconductor substrate 12). Combining voltage levels Vₚᵣₑ and V₁ for the program voltage PV in two portions of the same (first) program pulse reduces the overall program time. Further time is saved because there is no need to perform a program verify read operation PVR between the first and second portions of the first program pulse because preliminary voltage level Vₚᵣₑ alone is insufficient to program the memory cell to any of the target program states.

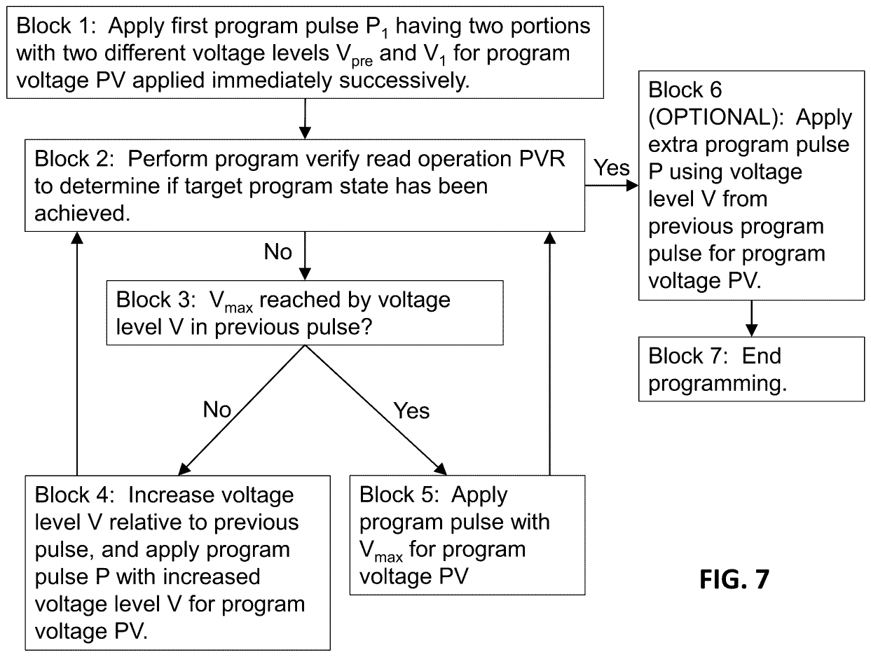

The second program parameter enhancement relates to the incremental increases to the voltage levels V of the program voltage PV of program pulses P, and specifically setting a maximum voltage level Vₘₐₓ as a limit on how high the voltage level V of the program voltage PV can reach. The programming method is illustrated in FIGS. 6-7. After program pulse P₁ (having two immediately successive portions with two different voltage levels Vₚᵣₑ and V₁ for the program voltage PV) is applied (Block 1 of FIG. 7), a first program verify read operation PVR₁ is performed to determine if the target program state has been achieved (Block 2). If the determination is no, then a determination is made whether the voltage level V in the previous program pulse (e.g., V₁ at this stage) has reached (met or exceeded) the maximum voltage level Vₘₐₓ (Block 3). If the determination is no, then the voltage level V of the program voltage PV is increased relative to the previous program pulse (e.g., increased from V₁ to V₂), and a second program pulse P₂ is applied with the increased voltage level V₂ for the program voltage PV (Block 4). A second program verify read operation PVR₂ is performed to determine if the target program state has been achieved (Block 2). If the determination is no, then a determination is made whether the voltage level V for the program voltage PV in the previous program pulse (e.g., V₂ at this stage) has reached the maximum voltage level Vₘₐₓ (Block 3). If the determination is no, then the voltage level V is increased relative to the previous program pulse (e.g., increased from V₂ to V₃), and a third program pulse P₃ is applied with the increased voltage level V₃ for the program voltage PV (Block 4), followed by a third program verify read operation PVR₃ to determine if the target program state has been achieved (Block 2). The process continues in the loop described above (Block 3, Block 4, Block 2) so long as the target program state is not achieved and Vₘₐₓ has not been reached. The process loop changes once the voltage level V of the program voltage PV for a program pulse P reaches Vₘₐₓ. When this occurs, then Block 5 is substituted for Block 4 in the loop, whereby all subsequent pulses P are applied with a program voltage level V for the program voltage PV of Vₘₐₓ (i.e., the voltage level V for the program voltage PV ceases to increase pulse to pulse, and instead has a fixed voltage level of Vₘₐₓ for all of the subsequent program pulses). Programming continues without increasing the voltage level V in a loop that includes Block 2, Block 3, Block 5 until the target program state is achieved (confirmed by a positive determination at Block 2). In the example of FIG. 6, program voltage level Vₘₐₓ is achieved at pulse Pₙ₋₂, whereby pulses Pₙ₋₂, Pₙ₋₁, Pₙ and P_{E} are applied with voltage level Vₘₐₓ for the program voltage PV. In this example, program pulses P₂-Pₙ₋₂ can be referred to as successive program pulses, and program pulses Pₙ₋₁-Pₙ can be referred to as second successive program pulses. By preventing program voltage V from exceeding Vₘₐₓ, stress and damage to the insulation layer between the floating gate 20 and the semiconductor substrate 12, as well as the insulation between the floating gate 20 any gate on which the program voltage PV is applied, are reduced.

The third program parameter enhancement relates to the termination of programming. Once a program verify read operation PVR determines that the target program state has been achieved (Block 2 of FIG. 7), then an extra program pulse P_{E} can be applied (Block 6) before programming ends (Block 7) to provide a margin between the target program state and the programmed state of the memory cell. The program voltage level V of the program voltage PV in extra program pulse P_{E} can be the same as the program voltage level V of the previous program pulse P (i.e. the program pulse that resulted in achieving the target program state). The margin provided by the extra program pulse P_{E} can allow for a slight downward drift in the program state of the memory cell that may happen over time (due to, for example, charge loss where electrons in the floating gate or intervening insulation materials are ejected or lost from the memory cell) without dropping below the target program state, thus reducing read errors when a slight downward drift of the program state occurs. The application of the extra program pulse P_{E} may be optional. In the example of FIG. 6, the target program state is achieved after program pulse Pₙ, as determined by program verify read operation PVRₙ. Thereafter, optional extra program pulse P_{E} can be applied.

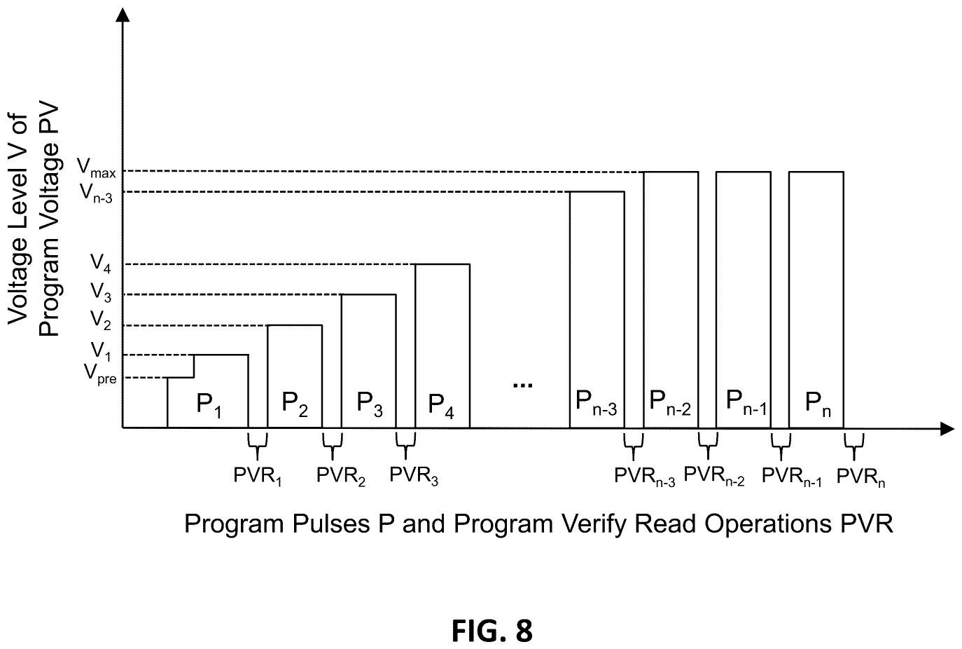

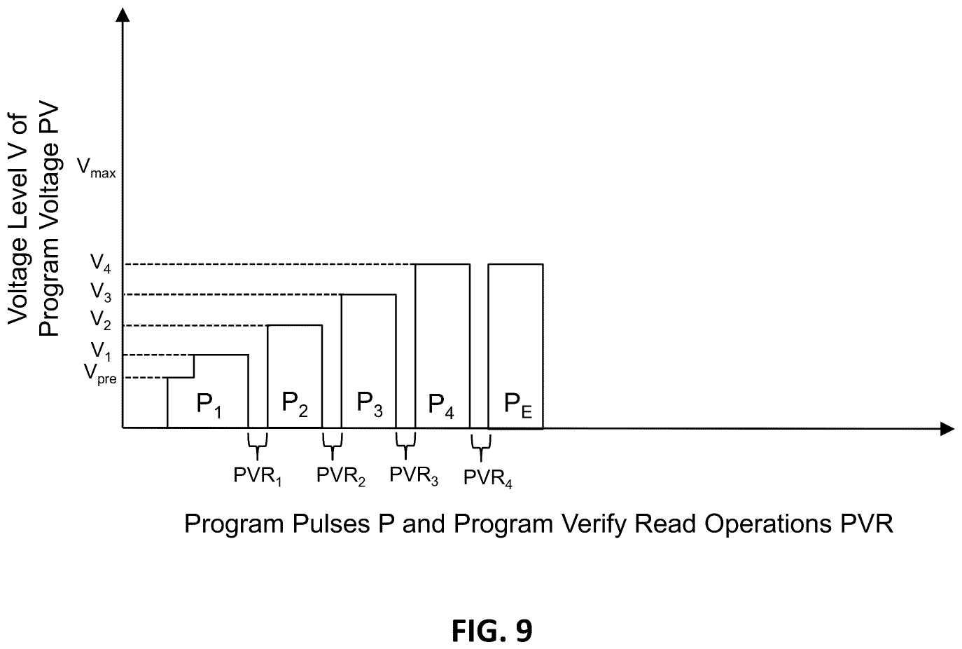

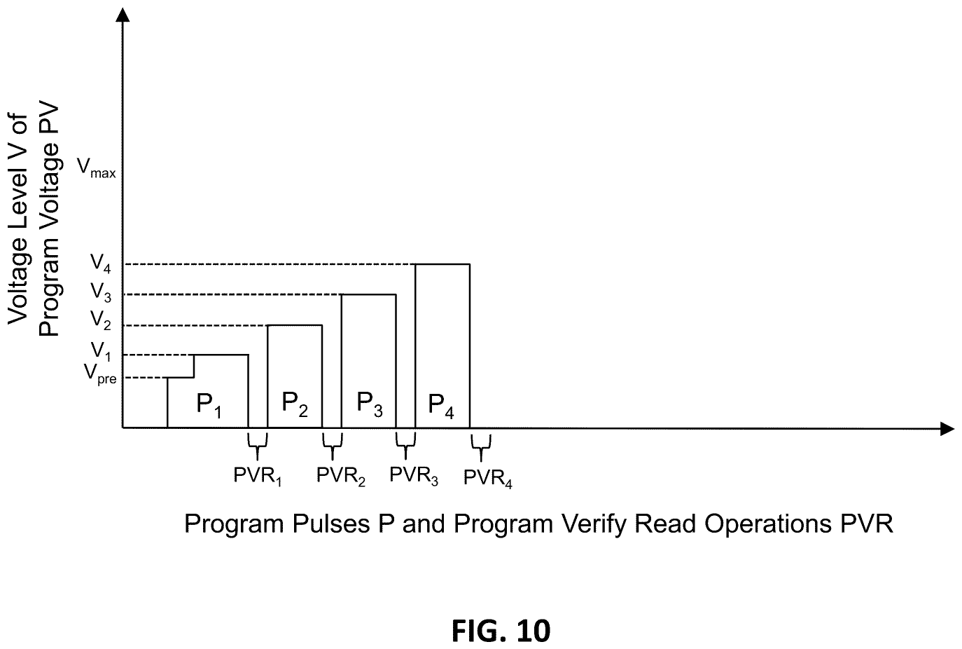

FIG. 8 illustrates another example of the program method, which is the same as that in FIG. 6 except that the extra program pulse P_{E} is omitted. FIG. 9 illustrates another example of the program method, which is similar to that in FIG. 6, but where the target program state is achieved after the fourth program pulse P₄. The program voltage level V of the program voltage PV for pulse P₄ is V₄, which is less than Vₘₐₓ. Therefore, FIG. 9 is an example of achieving the target program state before the maximum voltage level Vₘₐₓ is reached (i.e., a yes determination at Block 2 occurred without any yes determination at Block 3 occurred). FIG. 10 illustrates another example of the program method, which is the same as that in FIG. 9 except that the optional extra program pulse P_{E} is omitted. These examples illustrate that the number of pulses to achieve the target program state can vary, especially between different target program states (i.e., more program pulses may be needed for higher program states). Further, the maximum voltage level Vₘₐₓ need not be reached before achieving the target program state.

It is to be understood that the present disclosure is not limited to the example(s) described above and illustrated herein, but encompasses any and all variations falling within the scope of any claims. For example, references to the present disclosure or invention or examples herein are not intended to limit the scope of any claim or claim term, but instead merely make reference to one or more features that may be covered by one or more claims. Materials, processes and numerical examples described above are exemplary only, and should not be deemed to limit the claims. The claims are comprising claims unless otherwise stated, and therefore “each” of a plurality of elements having a limitation does not preclude the inclusion of additional such elements lacking the limitation unless otherwise specifically claimed. Finally, it should be noted that reference herein to circuitry, or a module of circuitry, or the like, to perform or configured to perform an operation refers to the physical structure of the circuit (i.e., the capabilities of the circuitry as dictated by its structure), and does not refer to any method or actual use of the circuitry.

What is claimed is:

1. A method of programming a memory cell having a floating gate, the method comprising:
applying a first program pulse to the memory cell to place electrons on the floating gate, wherein the first program pulse comprises a program voltage that includes a preliminary voltage level in a first portion of the first program pulse and a first voltage level in a second portion of the first program pulse, wherein the first voltage level is greater than the preliminary voltage level, and wherein the first voltage level is applied immediately successive to the preliminary voltage level; and
after applying the first program pulse, applying successive program pulses to the memory cell to place additional electrons on the floating gate, wherein the successive program pulses include the program voltage, and wherein the program voltage increases in voltage level for each one of the successive program pulses relative to a previous one of the successive program pulses or the first program pulse.

2. The method of claim 1, comprising:
performing a program verify read operation after the first program pulse and after each of the successive program pulses to determine a program state of the memory cell.

3. The method of claim 1, comprising:
after applying the successive program pulses, applying second successive program pulses to the memory cell to place additional electrons on the floating gate until a target program state for the memory cell is achieved, wherein the second successive program pulses include the program voltage, and wherein the program voltage has a fixed voltage level for all of the second successive program pulses.

4. The method of claim 3, comprising:
performing a program verify read operation after each of the second successive program pulses to determine a program state of the memory cell; and
determining the target program state for the memory cell is achieved based upon one of the program verify read operations.

5. The method of claim 3, comprising:
after applying the second successive program pulses and achieving the target program state for the memory cell, applying an extra program pulse to the memory cell to place additional electrons on the floating gate, wherein the extra program pulse includes the program voltage with the fixed voltage level.

6. The method of claim 1, comprising:
ceasing the applying of the successive program pulses upon achieving a target program state for the memory cell; and
after the ceasing, applying an extra program pulse to the memory cell to place additional electrons on the floating gate, wherein the extra program pulse includes the program voltage with a voltage level that is the same as a voltage level of the program voltage in a last one of the successive program pulses.

7. The method of claim 6, comprising:
performing a program verify read operation after each of the successive program pulses to determine a program state of the memory cell; and
determining the target program state for the memory cell is achieved based upon one of the program verify read operations.

8. The method of claim 7, wherein the ceasing the applying of the successive program pulses is based on the determining the target program state for the memory cell is achieved.

9. A semiconductor device, comprising:
a memory cell formed on a semiconductor substrate and having a floating gate; and
control circuitry to:
apply a first program pulse to the memory cell to place electrons on the floating gate, wherein the first program pulse comprises a program voltage that includes a preliminary voltage level in a first portion of the first program pulse and a first voltage level in a second portion of the first program pulse, wherein the first voltage level is greater than the preliminary voltage level, and wherein the first voltage level is applied immediately successive to the preliminary voltage level; and
after the first program pulse, apply successive program pulses to the memory cell to place additional electrons on the floating gate, wherein the successive program pulses include the program voltage, and wherein the program voltage increases in voltage level for each one of the successive program pulses relative to a previous one of the successive program pulses or the first program pulse.

10. The semiconductor device of claim 9, wherein the control circuitry to:
perform a program verify read operation after the first program pulse and after each of the successive program pulses to determine a program state of the memory cell.

11. The semiconductor device of claim 9, wherein the control circuitry to:
after the successive program pulses, apply second successive program pulses to the memory cell to place additional electrons on the floating gate until a target program state for the memory cell is achieved, wherein the second successive program pulses include the program voltage, and wherein the program voltage has a fixed voltage level for all of the second successive program pulses.

12. The semiconductor device of claim 11, wherein the control circuitry to:
perform a program verify read operation after each of the second successive program pulses to determine a program state of the memory cell; and
determine the target program state for the memory cell is achieved based upon one of the program verify read operations.

13. The semiconductor device of claim 11, wherein the control circuitry to:
after the second successive program pulses and achieving the target program state for the memory cell, apply an extra program pulse to the memory cell to place additional electrons on the floating gate, wherein the extra program pulse includes the program voltage with the fixed voltage level.

14. The semiconductor device of claim 9, wherein the control circuitry to:
cease the applying of the successive program pulses upon achieving a target program state for the memory cell; and then
apply an extra program pulse to the memory cell to place additional electrons on the floating gate, wherein the extra program pulse includes the program voltage with a voltage level that is the same as a voltage level of the program voltage in a last one of the successive program pulses.

15. The semiconductor device of claim 14, wherein the control circuitry to:
perform a program verify read operation after each of the successive program pulses to determine a program state of the memory cell; and
determine the target program state for the memory cell is achieved based upon one of the program verify read operations.

16. The semiconductor device of claim 15, wherein the cease of the application of the successive program pulses is based on the determination the target program state for the memory cell is achieved.
